(19) United States
(12) Patent Application Publication
(10) Pub. No.: US 2026/0320162 A1
(43) Pub. Date: Oct. 15, 2026

(54) SECURE CONTENT ACCESS UTILIZING PHYSICAL ARTICLE

(71) Applicant: Traveling Pendants LLC, Oakwood, OH (US)

(72) Inventors: Lesley Jones, Oakwood, OH (US); Aaron Michael Jones, Oakwood, OH (US)

(21) Appl. No.: 19/644,757

(22) Filed: Apr. 10, 2026

Related U.S. Application Data
(60) Provisional application No. 63/787,413, filed on Apr. 11, 2025.

(51) Int. Cl. G06F 21/31

(52) U.S. Cl. CPC G06F 21/31

(57) ABSTRACT

A system includes a physical article and a computer platform. A code, functioning as a unique identifier, is physically present with the physical article. The computer platform is operatively programmed to create a unique user account associated with the individual that possesses the physical article, and electronically link in a database, the user account with the code associated with the physical article. Additionally, the computer platform is operatively programmed to receive, via a remote client device, a login that provides credentials uniquely identifying the user account and the code. Responsive thereto, the computer platform enables a user to review on a display of the client device, a chain of previously collected entries that are uniquely associated with the code; enter a new entry to the chain via a text box of a graphical user interface, or both.

### CROSS REFERENCE TO RELATED APPLICATIONS

This application claims the benefit of U.S. Provisional Patent Application Ser. No. 63/787,413, filed Apr. 11, 2025, having the title “SECURE CONTENT ACCESS UTILIZING PHYSICAL ARTICLE,” the disclosure of which is hereby incorporated by reference in its entirety, as if expressly set forth herein.

### BACKGROUND

### Field of the Disclosure

Aspects of the present disclosure relate generally to the collection, access, and security of digital content. Aspects further relate to the collection, access, and security of digital content in a manner that utilizes a physical device.

### Description of Related Art

Many internet-based on-line platforms, including social media platforms, on-line shopping platforms, health-related platforms, manufacturer/product based platforms, etc., require user authentication so that such platforms can secure the content that is available or otherwise delivered to a corresponding electronic client device attempting to access such information.

The conventional approach to on-line access is to require an individual to enter a username and a password into a client device. This username and password combination is delivered to a remote server, where the username and password combination is cross-referenced with records stored in a corresponding database. The client device is granted access to content on the remote server if the entered username and password combination matches corresponding information stored in the database. On the other hand, access to the remote server is denied if a match cannot be made between the username and password combination and corresponding information stored in the database.

Unfortunately, such authentication techniques are not completely secure. Usernames are typically a person's email address or a variation of the individual's name. Passwords can be guessed, decrypted, hacked, or otherwise discovered.

### BRIEF SUMMARY

Aspects herein provide an article, such as a piece of jewelry, having at least one code thereon. The code is utilized to access a platform on a remote server to store, archive, retrieve, share, combinations thereof, content associated with the article and/or a possessor of the article.

According to further aspects herein, a system comprises a physical article and a computer platform. The physical article has a code physically present with the physical article. In this regard, the code is a unique identifier of the associated physical article. The computer platform is operatively programmed to electronically receive information about an individual that possesses the physical article. The computer platform is also operatively programmed to electronically receive a copy of the code, where the code is obtained from the physical article. For instance, the code can be manually entered into a client computer device, or the code can be electronically obtained, e.g., as read out by an optical scanner, wireless reader or interrogator, etc.

Additionally, the computer platform is operatively programmed to electronically create and store a unique user account associated with the individual that possesses the physical article, and to electronically link in a database, the user account of the individual that possesses the physical article with the code associated with the physical article. Moreover, the computer platform is operatively programmed to electronically receive, via a remote client device, a login to the computer platform, the login providing at least one of credentials that uniquely identify the user account, or the code of the associated physical article. Yet further, the computer platform is operatively programmed to communicate back to the client device, information that enables a user to review, on a display of the client device, a chain of previously collected entries that are uniquely associated with the code, or enter a new entry via a text box of a graphical user interface, such that when the data entry is completed, the new entry is concatenated to the chain of previously collected entries that is uniquely associated with the code.

According to yet further aspects herein, a system comprises a physical article and a computer platform. The physical article has a first code and a second code, both physically present with the physical article. Here, the first code is a unique identifier of the associated physical article, and the second code can be electronically read.

The computer platform is operatively programmed to electronically receive information about an individual that possesses the physical article. The computer platform is also operatively programmed to electronically receive a copy of the first code, where the first code is obtained from the physical article. For instance, the first code can be manually entered into a client computer device, or the first code can be electronically obtained, e.g., as read out by an optical scanner, wireless reader or interrogator, etc.

Additionally, the computer platform is operatively programmed to electronically create and store a unique user account associated with the individual that possesses the physical article, and to electronically link in a database, the user account of the individual that possesses the physical article with the first code associated with the physical article. Moreover, the computer platform is operatively programmed to electronically receive, via a remote client device, a login to the computer platform, the login providing at least one of credentials that uniquely identify the user account, or the first code of the associated physical article. Yet further, the computer platform is operatively programmed to communicate back to the client device, information that enables a user to review, on a display of the client device, a chain of previously collected entries that are uniquely associated with the first code, or enter a new entry via a text box of a graphical user interface, such that when the data entry is completed, the new entry is concatenated to the chain of previously collected entries that is uniquely associated with the first code.

### BRIEF DESCRIPTION OF THE SEVERAL VIEWS OF THE DRAWINGS

FIG. 1A is a block diagram illustrating an example digital/computer architecture for carrying out aspects of the present disclosure;

FIG. 1B is a flow chart illustrating a process for carrying out an electronic transaction to link content to an account associated with a physical article, according to aspects herein;

FIG. 1C is an example Graphical User Interface (GUI) on a computer device for reviewing a chain of transactions associated with a physical article, according to aspects herein;

FIG. 1D is an example of a GUI for entering information, where the collected information is associated with a physical article, according to aspects herein;

FIG. 2 is an example article implemented as jewelry, such as a pendant, where the view is seen from the front;

FIG. 3 is an example backside view of the article of FIG. 2;

FIG. 4 is a first example side view of an article, such as the jewelry of FIG. 2; and

FIG. 5 is a second example side view of an article, such as the jewelry of FIG. 2.

### DETAILED DESCRIPTION

Aspects of the present disclosure relate generally to a possession in the form of a physical article, and to the collection, access, and security of digital content that can be uniquely associated with that physical article. Aspects further relate to the collection, access, and security of digital content in a manner that is organized and/or secured based upon a code that is associated with that physical article.

A possession held by a first individual for a time may then be passed along to a second individual. This can be the case, particularly for a physical article such as a piece of jewelry, which is often acquired in response to an event of significance to the first individual. Unfortunately, the provenance, history, meaning, significance, etc., of such possessions can get lost over time.

However, aspects herein provide systems and processes for collecting, storing, and sharing digital content that can be uniquely associated with a physical article, e.g., a possession such as a piece of jewelry.

### Introduction and Example

According to aspects herein, a physical article (e.g., a piece of jewelry, such as a chain, necklace, pendant, talisman, watch, bracelet, etc.), includes a code (e.g., contained thereon or otherwise therewith). As will be described in greater detail herein, the code can be implemented in the form of an alpha, numeric, or alphanumeric code; a QR code; a bar code; a scannable or readable chip; other code, combination thereof, etc. Moreover, an individual that possesses the physical article can utilize a client computer device to interact with a computer platform on a remote server to create, modify, retrieve, review, or otherwise select content. That content is digitally entered into, or otherwise stored, in a data repository of the platform in a manner that is uniquely associated with the code of the corresponding physical article. In this regard, the code of the physical article can be used as an identifier, key, link, an authenticator, an aggregator, or for other purposes, examples of which are described more fully herein.

A physical article may be metal, plastic, a polymer, elastomer, or other suitable material. In this regard, in some embodiments, the code can be implemented in a form that is non-electrical and non-magnetic. For instance, the physical article can include a code that is printed or otherwise attached onto the article. As further examples, the code can be stamped, etched, engraved, embossed, embedded, molded, or otherwise applied to the physical article. The code can be implemented using symbols, a string of alpha, numeric or both characters, in the form of a QR code or bar code, etc.

In alternative embodiments, the code can be implemented in an electrical and/or magnetic device. Such a device can communicate wirelessly with a corresponding reader, interrogator, scanner, etc. Here, the device can be attached to, mounted on, embedded within, or otherwise integrated with a corresponding physical article. For instance, the code can be stored in a device such as a chip (e.g., a Radio Frequency identification (RFID) chip), Near Field Communication (NFC) tag, radio frequency tag (RF) tag, etc. Here, a suitable reader may likely be required to extract the code from the corresponding physical device.

In some embodiments, the code is a unique code that is not repeated across articles. For instance, in the manufacture of articles such as jewelry, the code can be serialized, randomized, or otherwise manufactured so that each piece of jewelry bears a unique code.

In an example implementation, a code is included on a physical article such as a piece of jewelry (e.g., a pendant, talisman, chain, etc.). The code functions as an identifier, key, link, an authenticator, an aggregator, or for other purposes.

Additionally, a computer platform includes a website and a data repository, where the repository is accessible to the website. In this regard, an individual that owns or otherwise possesses an associated piece of jewelry described above can utilize an electronic client device to navigate to the website, e.g., by entering a Uniform Resource Locator (URL) that identifies the location of the website. The owner can then enter or otherwise provide the unique code into an appropriate field of a graphical user interface (GUI) of the website. The user can also use the client device to upload other relevant information, such as an optional name or identifier, an optional contact such as an email or telephone number, etc.

The individual can also then also optionally enter, edit, modify, augment, or otherwise manipulate content, such as personal information, a story narrative, provenance information associated with the associated physical object, or other information that the individual wishes to preserve. In some embodiments, the individual can utilize the client device to upload media, e.g., video, photos, or other digital files as part of the content.

In yet other embodiments the individual can identify other miscellaneous data, such as whether the user is a purchaser, or recipient of the article, e.g., via a gift. Other information may include security information, information on who may access or view the entered information, etc., examples of which are described more fully herein.

The possessor may opt to pass the physical article to a second individual. That second individual can also use the platform and the code associated with the physical object to persist a chain of content across multiple individuals, where the provided content is linked back to the code of the physical object. In this regard, the ability to see, edit, share, and otherwise control any such content is described in greater detail herein.

### System Overview

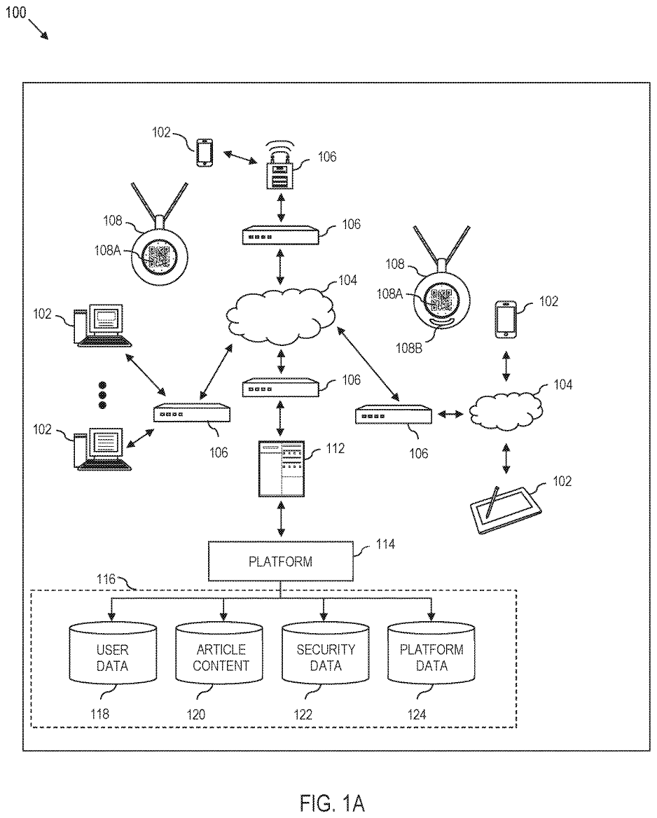

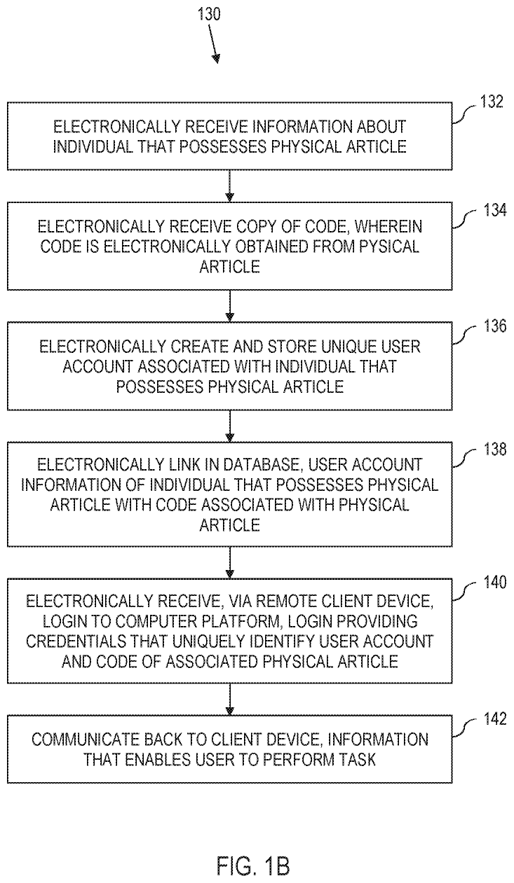

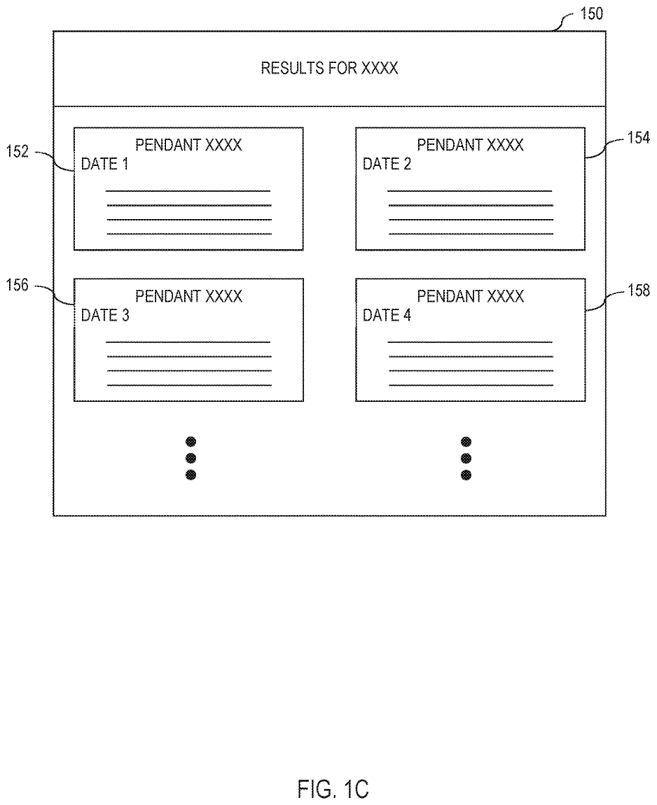

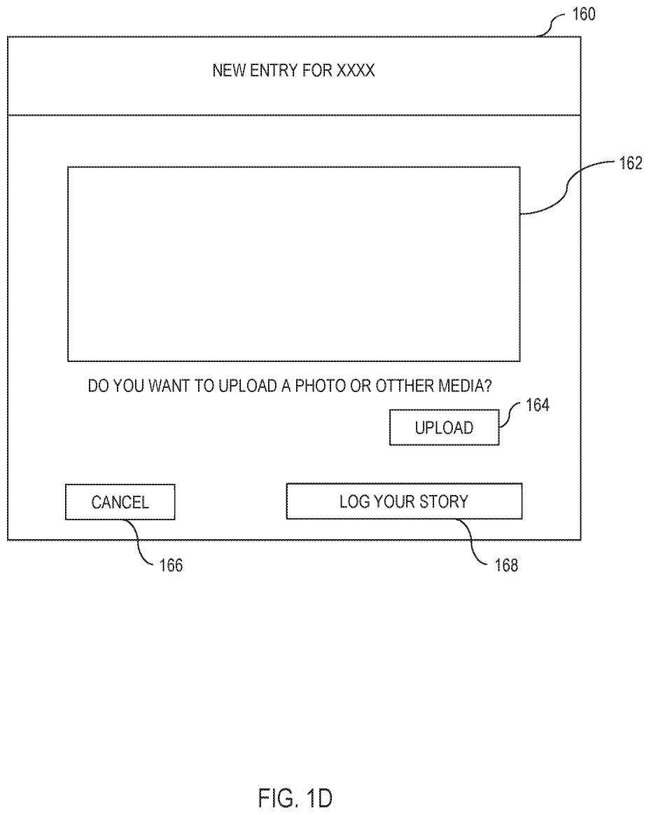

Referring now to the drawings and in particular to FIG. 1A, a general diagram of a computer system 100 is illustrated according to various aspects of the present disclosure. The computer system 100 comprises a plurality of hardware and/or software processing devices (designated generally by the reference 102) that are linked together by one or more network(s) (designated generally by the reference 104).

The network 104 provides communications links between the various processing devices 102 and may be supported by networking components 106 that interconnect the processing devices 102, including for example, routers, Wi-Fi routers, hubs, firewalls, network interfaces, wired or wireless communications links and corresponding interconnections, cellular stations and corresponding cellular conversion technologies (e.g., to convert between cellular and TCP/IP, etc.), access points, relays, etc. Moreover, the network(s) 104 may comprise connections using one or more intranets, extranets, local area networks (LAN), wide area networks (WAN), wireless networks (Wi-Fi), the Internet, including the world wide web, cellular and/or other arrangements for enabling communication between the processing devices 102, in either real time or otherwise (e.g., via time shifting, batch processing, etc.).

The processing devices 102 may comprise transactional systems, purpose-driven appliances, special purpose computing devices, general purpose computing devices, and/or other devices capable of communicating over the network 104. In certain contexts and roles, a processing device 102 is intended to be mobile, e.g., a smartphone, tablet, laptop, etc. In other embodiments, a processing device 102 can be generally stationary, e.g., a desktop computer, server, etc.

The illustrated computer system 100 also includes physical articles 108, which each contain one or more codes thereon. For sake of clarity of discussion, one illustrated physical article 108 includes a code 108A thereon. As another example, another illustrated physical article includes at least two codes, e.g., at least a first code 108A and a second code 108B.

The computer system 100 also includes a server 112 (e.g., a web server, file server, and/or other processing device) that supports a platform 114 and corresponding data sources (collectively identified as data sources 116). The platform 114 and data sources 116 provide the resources to implement the digital content collection, aggregation, curation, storage, delivery, accessibility, etc., as described in greater detail herein.

In an exemplary implementation, the data sources 116 are implemented by a collection of databases that store distinct types of information. In the illustrative example, the data sources 116 include databases from multiple, different domains, including a user data source 118, an article content data source 120, a security data source 122, and a platform data source 124. Such data sources 116 need not be co-located, and such data need not be logically organized as illustrated. Rather, the illustration herein provides a conceptual/logical framework from which aspects of the present disclosure can be understood.

As noted above, an individual (e.g., owner or possessor) having possession of a physical article 108 (e.g., a piece of jewelry) can utilize a processing device 102 (e.g., client device) to log onto the server 112 and thus access the platform 114. By interacting with the various data sources 116, the individual can use the associated processing device 102 (e.g., client device) to log in, upload content, create content, edit content, review content, link content, message other accounts on the platform 114, otherwise interact with the platform 114, combinations thereof, etc., examples of which are described in greater detail herein. In this regard, interactions with the platform 114 can be uniquely linked to a code (e.g., code 108A and/or code 108B) of the associated physical article 108.

### Example Interaction With the Platform

Referring to FIG. 1B, a process 130 is illustrated, which can be carried out by the platform 114 (FIG. 1A). In this regard, the entire disclosure with reference to FIG. 1A is incorporated into the discussion of FIG. 1B.

As noted in greater detail herein, a system can comprise a physical article 108 (FIG. 1A) having a code 108A (FIG. 1A) physically present with the physical article 108. By way of illustration, and not by way of limitation, the physical article can be a piece of jewelry (e.g., a chain, necklace, pendant, talisman, watch, bracelet, etc.). In this example, the code 108A is a unique identifier of the associated physical article 108. The system also includes a computer platform 114 (FIG. 1A). As illustrated with reference to FIG. 1B, the computer platform is operatively programmed to carry out operations to interact with an individual that possesses the physical article 108.

By way of introductory example, the platform can include a processor coupled to memory. The memory is configured with instructions such that when the processor reads out and processes the instructions, the platform implements instructions to interact with an end user.

Here, the computer platform is operatively programmed to electronically receive at 132, information about an individual that possesses the physical article. This may include a username for the individual, that links the individual to the platform. Other information may include the individual's name, email address, phone number, etc. For instance, the GUI may include a checkbox to distinguish whether the individual purchased the physical article or whether the individual received the physical article as a gift. Yet additional, non-limiting examples of information include media (e.g., photos, video, images, location data, story data, etc.

The computer platform is also operatively programmed to electronically receive, at 134, a copy of the code. In this regard, the code is obtained from the physical article. As noted more fully herein, the code, e.g., in the form of alpha characters, numeric characters, or a combination thereof, can be read by the individual, and the individual can manually type the code into a graphical user interface of the platform. This approach may be practical where the code is a string of characters (such as may be found on a keyboard). This may include letters, numbers, special characters, etc.

In other embodiments, the code is electronically obtained from the physical article. As an example, the individual can use a camera of a smartphone, or the individual can use another suitable device, to scan a QR code or bar code on the physical article. In yet further examples, the code is integrated into a chip that is attached or embedded to the physical article. Here, the individual can use an electronic reader or interrogator, e.g., a near field communication (NFC) chip, Radio Frequency ID (RFID), or other wireless reader in a smartphone or other device to wirelessly extract the code, e.g., from a chip embedded in or on the physical article.

As noted more fully herein, the code can provide information to the platform in a number of different contexts. For instance, the code of the physical article can be used as an identifier, key, link, an authenticator, an aggregator, or for other purposes. For instance, the code can be configured to uniquely identify the physical article. In this regard, the code is a unique code, which may be generated by serialized generation, randomized generation, user selection, etc.

Moreover, as noted in greater detail herein, the code can comprise a first code. Here, the physical article may further comprise at least one additional code physically present with the physical article. As a first example, the code can comprise a first code using alpha, numeric, or alphanumeric characters, whereas a second code can be implemented as a QR code on the physical article. As another example, the code can comprise one or more characters, where each of the one or more characters comprises a key that is available on a physical or virtual keyboard.

In some embodiments, the code is protected by an embossment. Where multiple codes are provided, each code may be but need not be protected by an embossment. Likewise, in some embodiments, the code is protected by a coating. Where multiple codes are provided, each code may be but need not be protected by the coating.

In an example implementation, at least one side of the physical article includes a recess. Here, the code can be seated in the recess. As a further example, the physical article can include a coating at least over the code in the recess. In another example, at least one side of the physical article includes at least one of projections, sidewalls, or an embossment that surround or circumscribe a recess, wherein the code is seated in the recess. Here, the physical article may include a coating at least over the code in the recess.

The computer platform is further operatively programmed to electronically create and store, at 136, a unique user account associated with the individual that possesses the physical article.

Moreover, the computer platform is operatively programmed to electronically link in a database, at 138, the user account of the individual that possesses the physical article with the code associated with the physical article.

The computer platform is still further operatively programmed to electronically receive at 140, via a remote client device, a login to the computer platform, the login providing credentials that uniquely identify the user account and the code of the associated physical article.

Responsive thereto, the platform is operative to communicate back to the client device at 142, information that enables a user to perform at least one operation. For instance, the individual can interact with the client computer device and one or more GUIs of the platform to review, on a display of the client device, a chain of previously collected entries that are uniquely associated with the code. As another example, the individual can interact with the client computer device and one or more GUIs of the platform to enter a new entry via a text box of a graphical user interface, such that when the data entry is completed, the new entry is concatenated to the chain of previously collected entries that is uniquely associated with the code.

In some implementations, the code functions as a digital key to an account on the platform. In this example, a second code, e.g., implemented as a QR code, can encode the uniform resource locator associated with the platform, such that when scanned by a client device, a browser on the client device navigates to the platform. As a different example, the second code can be implemented as a QR code, where both the first code and the second are required to log into an account on the platform associated with the physical article.

### Example Graphical User Interface

Referring to FIG. 1C, an example graphical user interface 150 illustrates an example where a user has logged onto or has otherwise navigated to the platform and has searched for a unique code associated with a corresponding physical article.

In some embodiments, the information collected by the platform is confidential to only those that possess the physical article. In other examples, information collected by the platform is confidential to only those that possess or have possessed the physical article. In yet other applications, the information ins not confidential and is thus open for any user of the platform to discover. For instance, in some implementations, a friend, family member, or even a stranger can access public information logged about a particular physical article.

Regardless, the GUI 150 illustrates an example chain of entries 152, 154, 156, 158 that are each associated with a given physical article. The entries 152, 154, 156, 158 can be provided by the same person, or different people that have possessed the physical article, or have otherwise been influenced, inspired, or otherwise have some connection to the physical device (e.g., an individual that gave the physical article as a gift may decide to generate an entry.

Each entry 152, 154, 156, 158 can comprise free form text, graphics, images, video, or any other information that conveys a message.

In some embodiments herein, a physical article, e.g., in the form of jewelry, is designed to wear and share. As the jewelry is passed from person to person, software implementing the platform 114 (FIG. 1A) can be utilized to create a “digital chain”.

Here, a “digital chain” represents one or more entries of content on the platform where the entries of content are linked by the same code of a corresponding physical article. In this regard, the entries of content associated with the digital chain can be from the same individual, or from two or more individuals that are associated with the same physical article (e.g., a first possessor and a second possessor). In this regard, the entries associated with the digital chain may be chronological or the entries can be arranged in other manners. Thus, for instance, a path of travel of the physical article and/or individual possessing the physical article may be captured and preserved.

In some embodiments, multiple individuals may have possessed the physical article and may thus have an account that is linked to the same physical article. The unique code of that physical article can enable the platform to create a digital chain of content, where different content entries can be made by different individuals. Moreover, some or all the individuals that had possession of the physical article may have continued visibility of the chain on the platform (despite passing the physical article on to another individual) thus allowing for instance, everyone on the chain to track the physical article 108, e.g., jewelry, as the physical article 108 travels, to access the new content as new wearers/possessors add any such new content, etc. However, in some embodiments, security features can provided that restrict or otherwise limit which individuals and/or client devices can access the logged information.

In some embodiments, access to content on the platform can be tailored based upon access/credentials. For instance, a user with access may be able to review all media to which the user is authorized to review. In some embodiments, users with limited credentials may be able to see certain content but are restricted from information such as personal identifying information. In some embodiments, views of data may be anonymized so that the content and personal identifying information are not accessible and undiscernible. In yet further embodiments, access can be denied outright. Examples of authentication and content delivery and accessibility are described in greater detail herein.

### Example Graphical User Interface

Referring to FIG. 1D, an example graphical user interface 160 illustrates an example where a user has identified a code associated with a physical article that has previously been registered with the platform. In this regard, a user may have logged onto or has otherwise navigated to the platform and has searched for a unique code associated with a corresponding physical article.

In this example, a user can interact with the graphical user interface 160 to enter new information. As illustrated, the example GUI includes a text box 162 for entering free form text about an experience. The example GUI 160 also includes a button 164 to upload media, such as photos, images, video, location data, etc.

The illustrated GUI 160 also includes buttons to cancel 166 the input of information, or to log 168, the entered information to an account associated with the physical article.

### Physical Article—Jewelry Example

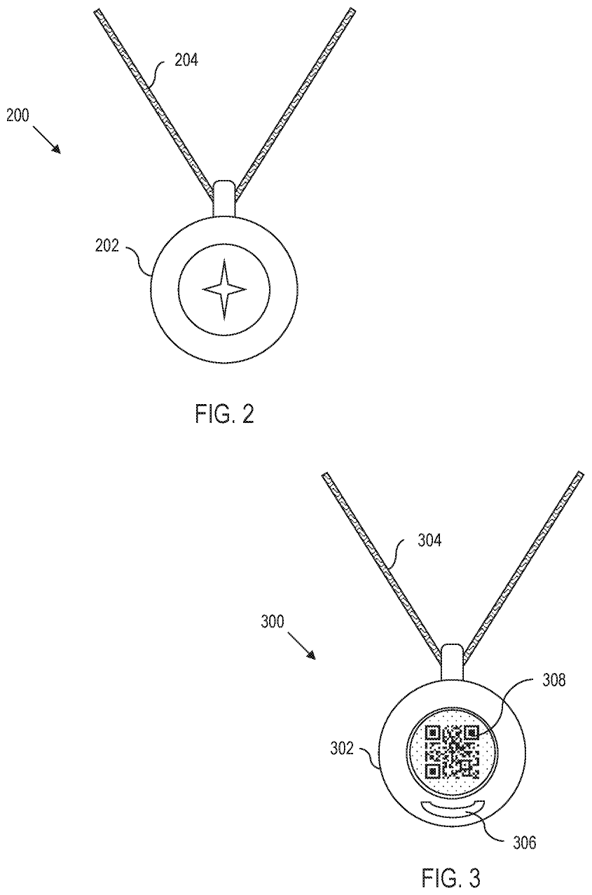

Referring to FIG. 2, an example physical article 200 is illustrated. The physical article 200 can incorporate any feature or features in any combination that are described throughout this document and other features described throughout this document can incorporate one or more features of the physical article 200 in any combination. For instance, the physical article 200 can be implemented as an example of the article 108 (FIG. 1A) using any techniques, systems, processes, etc., in any combination thereof, as described with reference to physical articles herein.

As shown for sake of clarity of discussion, the physical article 200 is in the form of a pendant 202 on a chain 204. The view of FIG. 2 is the front of the pendant 202.

Although shown as a pendant 202 for sake of example, the physical article 200 can include, for example, a piece of jewelry, such as a chain, necklace, talisman, watch, bracelet, etc. The pendant 202 includes one or more codes using any combination of features set out and described herein.

Referring to FIG. 3, an example physical article 300 is illustrated. The physical article 300 can incorporate any feature or features in any combination that are described throughout this document and other features described throughout this document can incorporate one or more features of the physical article 300 in any combination. For instance, the physical article 300 can be implemented as an example of the article 108 (FIG. 1A), and/or the back of the physical article 200 (FIG. 2) using any techniques, systems, processes, etc., in any combination thereof, as described with reference to physical articles herein.

The article 300 is illustrated as a pendant 302 attached to a chain 304. In this regard, the pendant 302 can be the same as the pendant 202 (FIG. 2), e.g., the back side of the pendant 202 (FIG. 2) and chain 304 can be the same as the chain 204 (FIG. 2). Likewise, the article 300 can be implemented as an example of the physical article 108 (FIG. 1A). In other implementations, the physical article 300 can be different from the physical article 108 (FIG. 1A) and/or physical article 200 (FIG. 2).

In FIG. 3, the backside of the pendant 304 is illustrated. In the example shown, the pendant 304 includes at least one code. As illustrated, there are two codes, including a first code 306 and a second code 308.

The first code 306 can comprise a code of one or more characters. For instance, each of the one or more characters can comprise a character derived from a key that is available on a physical or virtual keyboard. For instance, the code 306 can comprise one or more numbers (a numeric code), one or more letters (an alpha code), an alpha-numeric code, an alphanumeric code that includes special characters, etc.

The first code 306 can also comprise a QR code, bar code, or other scannable code. Yet further, the first code 306 can comprise a chip that can be read out by a suitable reader, including a reader that is available in a smart phone, e.g., a Near Field Communication chip, Radio Frequency ID (RFID), etc. Such chips are well suited to this application as these chips do not require a battery for power.

In some embodiments, the code 306 is unique to the associated pendant 302 so that no other physical article carries the same code. In some embodiments, the code is unique to the article type (e.g., each pendant has a unique code 306, each talisman has a unique code 306, but a pendant and a talisman can each have the same code 306, such as where article type is also used as an identifier.

In some embodiments, a second code 308 is provided. Analogous to that described above, the second code 308 can comprise a code of one or more characters, one or more numbers (a numeric code), one or more letters (an alpha code), an alpha-numeric code, an alphanumeric code that includes special characters, etc.

The second code 308 can also comprise a QR code, bar code, or other scannable code analogous to that described above. Yet further, the second code 308 can comprise a chip that can be read out by a suitable reader, including a reader that is available in a smart phone, e.g., a Near Field Communication chip, Radio Frequency ID (RFID), etc.

In an example implementation, the second code 308 is a QR code. In some embodiments, the QR code is a common code that provides a link to a corresponding computer platform (e.g., the platform 114, FIG. 1A). In other embodiments, the QR code is unique to each article (or article type).

Where the first code 306 and/or the second code 308 are unique, the generation of the code(s) can be serialized, random, user selected (e.g., in a custom made to order application) or otherwise generated to be unique.

Although shown on the back of the pendant 302 for clarity of discussion, the first code 306 and/or the second code 308 can be on the front, side, or other suitable location.

Moreover, the first code 306 and/or second code 308 can be stamped, embossed, printed, screened, formed, carved, engraved, laser cut, embedded or otherwise applied to the pendant 302.

Yet further, in some embodiments, features such as coatings, protectants, sealants, embossments, projections, and other features can be implemented to protect the first code 306 and/or second code 308, examples of which are described herein.

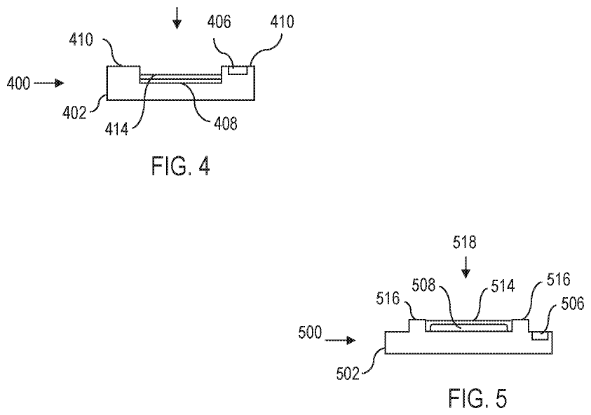

Referring to FIG. 4, an article 400 is illustrated. The article 400 can incorporate any feature or features in any combination that are described throughout this document.

The article 400 can comprise a piece of jewelry such as a pendant 402. In this regard, the pendant 402 can be the same as the pendant 302 (FIG. 3), pendant 202 (FIG. 2), article 108 (FIG. 1A) or any combination thereof. Analogous to the description of FIG. 3, the pendant 402 includes at least two codes. For instance, the pendant 402 includes a first code 406 (e.g., analogous to the first code 306, FIG. 3). The pendant 402 also includes a second code 408 (e.g., analogous to the second code 308, FIG. 3).

FIG. 4 illustrates an example embodiment where the back of the pendant 402 includes projections or sidewalls 410 that surround or circumscribe a recess 412. The second code 408 (e.g., a QR code) is seated in the recess 412.

An optional coating 414 coats the second code 408 (e.g., QR code) seated in the recess 412. The coating protects the second code 408 from use, e.g., due to wear, bodily fluids such as sweat, etc.

Referring to FIG. 5, an article 500 is illustrated. The article 500 can incorporate any feature or features in any combination that are described throughout this document.

The article 500 can comprise a piece of jewelry such as a pendant 502. In this regard, the pendant 502 can be the same as the pendant 402 (FIG. 4) except as where otherwise expressly expressed. The pendant 502 can also/alternatively be the same as the pendant 302 (FIG. 3), pendant 202 (FIG. 2), article 108 (FIG. 1A) or any combination thereof.

Analogous to the description of FIG. 3 and FIG. 4, the pendant 502 can include at least two codes. For instance, the pendant 502 includes a first code 506 (e.g., analogous to the first code 306, FIG. 3 and/or first code 406, FIG. 4). The pendant 502 also includes a second code 508 (e.g., analogous to the second code 308, FIG. 3 and/or second code 408, FIG. 4).

FIG. 5 illustrates an example embodiment where the back of the pendant 502 includes projections such as an embossment, raised projection, rim, or other structure that extends outward from the back surface to define a well 518. The second code 508 (e.g., a QR code) is seated in the well 518.

An optional coating 514 coats the second code 508 (e.g., QR code) seated in the well 518. The coating protects the second code 508 from use, e.g., due to wear, bodily fluids such as sweat, etc.

### Code(s)

In some embodiments, a first code (e.g., first code 108A, FIG. 1A; first code 406, FIG. 4; first code 506, FIG. 5) is a code that is utilized as a digital key to sort, store, locate, and otherwise identify an account on a platform (e.g., platform 114, FIG. 1A). In this regard, the platform 114 can function as a digital storyboard or story telling platform that uniquely captures content, e.g. stories, media such as pictures and/or video, digital files, etc., which are uploaded, typed, entered, or otherwise provided through a client device (e.g. processing device 102, FIG. 1A) utilized by a possessor of the article bearing the code(s).

In some embodiments the second code (e.g., second code 408, FIG. 4; second code 508, FIG. 5) is a QR code. For instance, in a first example implementation, the QR code is a link that takes a user to the platform, e.g. platform 114 (FIG. 1A).

In a second example, the QR code is unique and/or unique to other QR codes attached to physical articles. As another example, the QR code can be linked or otherwise associated with the corresponding first code. This can allow user convenience, such as auto populating a form in the digital story telling platform. For instance, scanning the QR code can take the user's client device to an account keyed by the first code so that at least a portion of information is auto-populated based upon previously provided information as described more fully herein. For instance, a physical article can have a first code, e.g., a serial number such as 205. The physical article may also have a second code in the form of a QR code. If a user scans the QR code, the serial number of the first code (e.g., 2005 in this example) can automatically autopopulate in a form on the platform.

In some embodiments, one or more of the first code and/or the second code are required to log into an account, e.g., to append, modify, revise content.

In some embodiments, each of the first code and the second code are distinct, and serve as a multi-part authentication process, e.g., requiring the scanning of the QR code and the entry of the first code.

In some embodiments, a user can utilize a client device to access a platform (e.g., see processing device 102 to log into platform 114). For instance, where the platform functions as a story telling platform, the user can utilize the client device to browse public stories, to read publicly available stories, etc. In some embodiments, the stories are sorted by category (e.g., cancer survival, divorce, redemption, sobriety, travel, parenting, etc.).

In some embodiments, one or more of the first code and the second code can be utilized to track a corresponding article, e.g., to read stories of individuals that have possessed the same article and shared a story to the platform, etc.

In yet further embodiments, the first code and/or second code can be utilized to log into the platform, e.g., to add, modify, revise, or otherwise manipulate content related to the article associated with the code(s).

In an example embodiment, a code, e.g., a QR code can be used to collect data by the platform. For instance, the QR code can interact with program code (e.g., on the client device that scans the QR code, or otherwise), to collect data that is then conveyed to the platform, e.g., location of the QR code scan, time of the scan, date of the scan, other data, combinations thereof, etc. This collected information can be automatically stored with the account associated with the physical article. For instance, the collected information can be automatically entered into a story, used as a key to search for stories or content associated with a physical article, etc. Thus, scans of the QR code can be utilized to create a journey map that captures physical data as well as capturing the story that the possessor wants to log.

### Example Concepts

Referring to the FIGURES generally, in a non-limiting working example, a physical article is implemented as a pendant. The pendant includes a first code, implemented as a numeric code, designating a pendant number. The pendant also includes a QR code, which can be scanned to access the platform.

In use, a wearer/possessor scans and then registers their pendant number. Once an account is set up and is tied to the pendant, the possessor can log their strength story to the pendant via a graphical user interface of the platform. As the pendant is worn and then passed on, a corresponding computer system ties the wearers personal narratives (strength stories) to the jewelry to create a larger story; each wearer can become a chapter in the larger narrative/story of the pendant. Everyone who has worn the pendant can read the powerful, evolving story (register and track the jewelry).

In some embodiments, each article (e.g., jewelry such as a talisman, pendant, etc.) has a serialized, random, assigned, or otherwise unique QR code (second code), as well as a first code implemented as a number or character code that identifies the article and functions as an identifier (e.g., 2001-GHLR).

In some embodiments, there is no separate key (a key being a separate code that a user must have). Here, the necessary identifying information is only available on the physical article (e.g., pendant). For instance, to access the account, e.g., to add, edit, etc., the QR code and/or first code may be required. In some embodiments, the first code is redundant to the QR code. The QR code is serialized or otherwise unique, and the first code is an etched code on the article, e.g., near the QR code, to correlate with the QR code so that the physical article can be registered (tied to a person's real life story) and tracked once passed on. Here, one can scan the QR code or enter the first code. This redundancy provides a safeguard in case the article is damaged or one of the codes is damaged or otherwise obfuscated due to wear. In yet further embodiments, a separate key can be provided, e.g., which is intended to stay with the original purchaser. This key can serve as a master key, or the key can serve as a stay behind so that the original purchaser can track the article once passed on.

In some embodiments, each QR code has a number with a key-such that when someone scans the QR code, the client device utilized by the user presents a prompt, such that the user has to enter the key to register their narrative to the pendants larger story and get access to the other stories the pendant has collected. Only people with the pendant, the serialized code, and the key (all which can only be found on the pendant itself) can access this information (or a selected subset thereof).

In some embodiments, as a user utilizes the first and/or second code on a client device to access the platform, the platform presents via a GUI, a prompt that allows the user to opt in to keep their stories private (only accessible to those on the digital chain) or public (posted the a larger section such as a “strength stories” page) or both. Here, a digital chain is the stories and content provided by different users/different possessors of the same article (e.g., same pendant, talisman, bracelet, etc.).

In some embodiments, when a client device scans the QR code, the client device automatically launches a browser that navigates to the URL of the platform. For instance, the QR code can store a link to the platform. In some implementations, data extracted from the QR code can be extracted automatically passed to the platform so that the platform automatically receives the scanned pendant number. The auto populated pendant number can be loaded into a form on a GUI of the platform, e.g., for interacting with stories.

In some embodiments, when a client device transmits the first code, second code or both to register their article (e.g., pendant) and digitally log their story on the platform, everyone else on the digital chain gets a notification that there is a new story that has been shared to the pendant's growing narrative.

In some embodiments, the pendant becomes a digital chain/digital communication gateway. Every time the client device of a person scans the QR code and optionally enters the security key defined by the first code everyone on the digital chain is notified (sent a push notification).

As another example, users associated with a corresponding digital chain could have the new narrative that was logged delivered directly to their inbox. As yet a further example, users associated with the digital chain could have the entire digital chain (all the logged strength story narratives) delivered directly to their inbox/device.

In yet another example embodiment, a digital chain only exists because of the physical object of the pendant. Here, the content of the digital chain is only accessible to people who wear/possess the pendant, and the digital chain only grows when people share the object. Here, past owners may continue to have access to the contents of the chain. In some embodiments, each link in the chain (each person associated with a possession of the article, can choose what parts of the content can be public, what parts can be shared downstream of the chain, what parts can be shared upstream of the chain, what parts are exclusive to the current owner of the chain, any combination of the above, etc.

In some embodiments, if a user is part of a digital chain (have received the pendant) but don't want to share their story or aren't ready to share yet, that user can still be part of the pendant's chain and opt in to connect with those who have worn the pendant (are on the chain) and receive ongoing updates when the pendant continues to travel and the chain (of people and stories) grows.

In some embodiments, when a user utilizes a client device to scan the QR code on an article, that user may be prompted to create an account (e.g., if an account for that user currently does not exist). Once logged in and tied to the specific digital chain for that article (every pendant would be its own digital chain) the user can “track it” from their account (read the stories carried by the pendant as such stories are added) etc. The user may also be able to send push notifications, such as when there is a new story added.

In some embodiments, every user who is on a corresponding digital chain (e.g., everyone who has worn the pendant and registered their story) are able to connect securely with one another and continue to share updates with one another. In some embodiments, each user can create and optionally share their own private blog, such as where the user can communicate with one another, share stories, add updates to the pendants narrative about themselves, etc. This can, in some instances, be utilized such as to create a mini support group of people connected on this digital chain created by the wearing and sharing of this one particular article (e.g., pendant).

In some embodiments, there may be a special ink coating to emboss the first code and/or the second code (e.g., the QR code) so that the code lasts on the article, which may be sterling silver, gold, etc.

In some embodiments, a unique process is provided, the register, wear, share, track process, which creates a digital data chain where the data are chapters in the larger narrative of the article (e.g., a pendant) (where the article has been, what personal stories the article carries).

The process creates a series of digital chains, where each chain is associated with a different article. Each chain may generate a chain of support created through a physical object (such as jewelry). Without the physical object being passed from person to person, the digital chain does not grow.

In some embodiments, a process is provided that allows an individual to digitally memorialize a memory or story associated with a physical piece of jewelry via one or more codes as set out more fully herein.

In some embodiments, the first code authenticates the individual to the platform for purposes of accessing accounts, editing, or adding to digital chains, etc. The second code (e.g., QR code) can be presented to others, e.g., family and/or friends, who can scan the QR code to easily access the digital chain (or portions of the digital chain) that are designated to security associated with the QR code. For instance, there may be one level of detail open to the public, which is generic. By scanning the QR code, a second level of security may be provided, which allows access to a greater amount of content less than full access. By presenting the first code (and/or first code and QR code, a user may be granted even greater access, including up to full access to an account.

In some embodiments, the QR code can be recessed into the back of the article (e.g., pendant) so that the QR code does not touch the skin or other surface that would otherwise rub the code. This prevents the code from wearing away due to rubbing/friction. In alternative embodiments, the first code is recessed into the back of the article. In yet further embodiments, both the first code and the second code (e.g., QR code) are recessed into the back of the article.

In some embodiments, when a user registers and logs into the platform, that user is tagged by the platform based on a topic of what strength story that user wants to share (recovery, addiction, divorce, cancer, faith, support, etc.). In some embodiments not only can the user opt in to get updates from their pendant chain, but the user can also opt in to receive stories around their subject matter interests for inspiration from other wearers in the same category(ies). In yet another example, there may be an option to connect the people in these subgroups/categories with one another in a secure group on the platform almost like a support group (such as a group of cancer warriors, divorce, sobriety and addiction, mental health, motherhood, etc.).

In some embodiments, an object securely collects a registration where the registration associates a name with the article and logs a personal narrative of the registrant to memorialize his/her narrative (e.g., a process to register an article such as a pendant, and log a story). In some embodiments, the article is made specifically for the purpose of traveling from person to person (wear and share, i.e., made to be passed on to collect stories). Once the article is passed, registrations are collected, and the story logs associated with the new owner at the time. Thus, the article memorializes the registrations and story logs, securely links everyone who comes into contact with the object, etc. The only way to be part of the digital chain is to have owned the same article. Everyone on the chain can opt in to share their log to the others on the chain. A user can track to read the narratives that have come beforehand and once shared, the narratives that come after the article is passed along. A user effectively becomes a link in a chain of support through creating this digital chain from a tangible object.

In some embodiments, a client device can run an app that interacts with the platform to carry out aspects described more fully herein.

In some embodiments, the platform will allow a user to keep track of all the pendants the user gifts once that user logins to the user's account. As another example, once a user purchases an article, the platform may correlate the pendant with that user at purchase even before that user is able to create an account. In a sense the birth of the pendants story becomes the first person who purchases it. In this example, there may be a registration made at “birth” stating the pendants birth date (day of purchase) and where the pendant is being sent.

Some implementations do not require two or more codes. For instance, a single code such as the first code may suffice. The first code can correlate an identification of an owner automatically. The platform can use the code to determine who receives a push notification to register an account, register their article and log their story, etc. When the individual passes the article along the receiver can utilize a client device to navigate to the platform, create an account, and then enter the corresponding code (e.g., from the back of the physical article). The new user would then be added by the platform to that pendant number's digital story chain.

In some embodiments, stories can be autonomized. For instance, in some instances, it may be desirable to capture a story, but conceal the identity of the possessor. Here, the platform can use processing techniques to autonomize personal identifying information. This can involve techniques like data deletion, masking, generalization, perturbation, or swapping.

### Miscellaneous

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A system comprising:
a physical article having a code physically present with the physical article, wherein the code is a unique identifier of the associated physical article;
a computer platform, the computer platform operatively programmed to:
electronically receive information about an individual that possesses the physical article;
electronically receive a copy of the code, wherein the code is obtained from the physical article;
electronically create and store a unique user account associated with the individual that possesses the physical article;
electronically link in a database, the user account of the individual that possesses the physical article with the code associated with the physical article;
electronically receive, via a remote client device, a login to the computer platform, the login providing at least one of credentials that uniquely identify the user account, or the code of the associated physical article;
communicate back to the client device, information that enables a user to perform at least one of:
review, on a display of the client device, a chain of previously collected entries that are uniquely associated with the code; or
enter a new entry via a text box of a graphical user interface, such that when the data entry is completed, the new entry is concatenated to the chain of previously collected entries that is uniquely associated with the code.

2. The system of claim 1, wherein the physical article comprises a piece of jewelry.

3. The system of claim 2, wherein the jewelry comprises a select one of a bracelet, a talisman, a necklace, a watch, a pendant, or a chain.

4. The system of claim 1, wherein:
the code comprises a code of alpha characters, numeric characters, or a combination thereof.

5. The system of claim 1, wherein:
the code is electronically obtained from the physical article; and
the code comprises a QR code or a bar code.

6. The system of claim 1, wherein:
the code is integrated into a chip that is attached or embedded to the physical article.

7. The system of claim 1, wherein:
the code is a unique code generated by at least one of:
serialized generation;
randomized generation; or
user selection.

8. The system of claim 1, wherein:
the code comprises a first code, the physical article further comprising:
at least one additional code physically present with the physical article.

9. The system of claim 1, wherein:
the code comprises a first code comprising alpha, numeric, or alphanumeric characters, further comprising a second code implemented as a QR code on the physical article.

10. The system of claim 1, wherein the code is protected by an embossment.

11. The system of claim 1, wherein the code is protected by a coating.

12. The system of claim 1, wherein at least one side of the physical article includes a recess, wherein the code is seated in the recess.

13. The system of claim 12, wherein the physical article includes a coating at least over the code in the recess.

14. The system of claim 1, wherein at least one side of the physical article includes at least one of:
projections;
sidewalls; or
an embossment,
that surround or circumscribe a recess, wherein the code is seated in the recess.

15. The system of claim 14, wherein the physical article includes a coating at least over the code in the recess.

16. The system of claim 1, wherein the code functions as a digital key to an account on the platform.

17. The system of claim 16 further comprising a second code implemented as a QR code that encodes the uniform resource locator associated with the platform, such that when scanned by a client device, a browser on the client device navigates to the platform.

18. The system of claim 16 further comprising a second code implemented as a QR code, wherein both the first code and the second are required to log into an account on the platform associated with the physical article.

19. A system comprising:
a physical article having a first code and a second code, both physically present with the physical article, wherein the first code is a unique identifier of the associated physical article, and the second code can be electronically read;
a computer platform, the computer platform operatively programmed to:
electronically receive information about an individual that possesses the physical article;
electronically receive a copy of the first code, wherein the first code is obtained from the physical article;
electronically create and store a unique user account associated with the individual that possesses the physical article;
electronically link in a database, the user account of the individual that possesses the physical article with the first code associated with the physical article;
electronically receive, via a remote client device, a login to the computer platform, the login providing at least one of credentials that uniquely identify the user account, or the first code of the associated physical article;
communicate back to the client device, information that enables a user to perform at least one of:
review, on a display of the client device, a chain of previously collected entries that are uniquely associated with the first code; or
enter a new entry via a text box of a graphical user interface, such that when the data entry is completed, the new entry is concatenated to the chain of previously collected entries that is uniquely associated with the first code.

20. The system of claim 19, wherein the second code is a code is a link to the platform.
